(19) United States
(12) Patent Application Publication
(10) Pub. No.: US 2025/0363384 A1
(43) Pub. Date: Nov. 27, 2025

(54) TRANSFER LEARNING FOR PERFORMANCE PREDICTION

(71) Applicant: Telefonaktiebolaget LM Ericsson (publ), Stockholm (SE)

(72) Inventors: Jalil TAGHIA, Stockholm (SE); Isak PERSSON, Stockholm (SE); Xiaoyu LAN, Täby (SE); Masoumeh EBRAHIMI, Solna (SE)

(21) Appl. No.: 18/871,919

(22) PCT Filed: Jun. 21, 2022
(86) PCT No.: PCT/EP2022/066923

§ 371 Date: Dec. 5, 2024

(51) Int. Cl. G06N 3/096; G06N 3/045

(52) U.S. Cl. CPC G06N 3/096; G06N 3/045

(57) ABSTRACT

A method, system and apparatus are disclosed. A method implemented in a source network node configured to communicate with a target network node is provided. A source data set is obtained. A source model is trained based on the source dataset, where the training includes generating a source memory matrix and a source link matrix. The source memory matrix and the source link matrix are transmitted to the target network node, which causes the target network node to train a target model. The training of the target model includes initializing a target memory matrix and a target link matrix based on the source memory matrix and the source link matrix.

### TECHNICAL FIELD

The present disclosure relates to wireless communications, and in particular, to transferring learning from a source model in a source node to a target model in a target node.

### BACKGROUND

### Transfer Learning

Transfer learning is a machine learning technique focusing on transferring knowledge between different but similar domains. One could, for example, train a model on Task A (e.g., Task A may be prediction of average read latency given data collected from a data center) and then transfer what has been learned to solve Task B, which is a task that is somewhat related to but not the same as Task A (e.g., Task B may be prediction of average write latency given data collected from a data center). By taking advantage of/applying what has been learned from similar domains to the target domain, increased performance, better generalization, and the reduced need for target domain data can be achieved.

Transfer learning has been studied in different contexts. For example, the transductive transfer learning problem may use feature representation-based and instance-based approaches.

Transductive transfer learning may be used when the target task is the same as the source task, but the domains are different. For example, if the task includes prediction of the service level agreement from measurements collected from a radio base station in a wireless network, after an upgrade, the domain may change, however, the underlying task of the use case remains the same as before.

An instance-based approach may be used when the source domain is assumed to be similar enough to the target domain such that the source data can be reused to be trained together with the target data. Examples of such techniques include instance reweighting and importance sampling.

A feature-representation-based approach learns good/useful feature representations from the source data and then applies the learned representations to the target data. The assumption is that the way of representing data can contain useful information for the target task.

### Transfer Learning in Timeseries

Existing systems have considered how to apply transfer learning to timeseries data.

For example, one transfer learning method in regard to instance-based methods is importance weighting. This method attempts to solve the problem of having different input distributions between the source and the target data. It does this by weighing the samples by the ratio between the target and source input densities.

### Differentiable Neural Computers

A differentiable neural computer (DNC) is an architecture including a neural network (controller) and an external memory matrix from which the neural network can read and write. FIG. 1 depicts a visualization of one example differentiable neural computer (DNC) architecture. The entire architecture is differentiable, allowing the neural network to learn how to operate and manipulate the external memory end-to-end with gradient descent. By having an external memory that the neural network can read and write from, the network can encode the input data and store it in the memory, allowing it to remember data over long timescales.

The controller interacts with the external memory based on three different mechanisms: Content-based addressing, Dynamic memory allocation, and Temporal memory linkage. Content-based addressing can be thought of as the mechanism that allows the controller to communicate directly what content to write into and read from the memory. Dynamic memory allocation controls where to free and allocate memory by having a usage counter for each memory cell. Lastly, temporal memory linkage is the mechanism that allows the DNC to remember which order data is written into the external memory.

The flow of the DNC is depicted in FIG. 1. First, the input goes through the controller, which then outputs a hidden state ht. This state is sent to the predictive layer as well as the memory interaction component. Using the hidden state, the DNC will decide what should be written to the memory as well as where it should be written to. Furthermore, the DNC uses the hidden state to decide what to read from memory. The write and read to memory happen in the memory interaction component. From the memory interaction component, what is read is sent to the predictive layer as well as to the next time step for the controller. The predictive layer uses what has been read from memory and the hidden state to make a prediction. Known systems may also require use the of same controller arrangement in the source and the target.

### SUMMARY

Some embodiments advantageously provide a method and system for training a source model and transferring the learning to a target model. Some embodiments include methods in a source network node and a target network node.

The transferring of learning may include transferring the “experience” of the source model. The “experience” of a DNC contains encodings of the source data, which is passed to the target model. The experience in this context is contents of the external memory of the DNC. It may also additionally include contents of the link matrix of the DNC (also known as the memory linkage matrix). Note that the memory matrix and the link matrix belong to the parameter set of the DNC.

This is similar to the instance-based approach in that the source data is transferred, however, it is the encodings of the time series and not the original instances. Instance-based approaches typically consider the dissimilarities of the source and target distribution. The techniques disclosed herein, by contrast, do not necessarily consider the data distributions (e.g., of the source dataset/domain and target dataset/domain). The techniques disclosed herein may utilize feature-representation-based approaches that try to apply learned representation from the source to the target data. Transferring the memory, as stated previously, may encourage the target controller to learn how to represent the time series similarly to how the source controller represents the data. Lastly, the memory may include a matrix of parameters that the trained model learns as it passes through the timeseries data. This may be considered a parameter-based approach.

A method is disclosed to train a model on the source data and then transfer a subset of the experience to the untrained target model. In this disclosure, the part of the experience that is being transferred may include the memory matrix and/or link matrix. The memory matrix and the link matrix of the source DNC model (e.g., at the last timestamp of the DNC model) may be transferred to the target domain. These matrices may be used to initialize the memory matrix and/or the link matrix of the DNC at the target domain/node, e.g., at the first timestamp of the training period in the target domain/node. The target model is then allowed in the consecutive timesteps to update the experience (matrices) by itself.

A method is disclosed for transferring knowledge learned in one DNC model at the source domain (and/or node) to a DNC model at the target domain (and/or node). This may be achieved through transferring the external memory matrix and/or the link matrix of the DNC in the source domain (and/or node) (e.g., at the final timestamp of the timeseries data at the source domain) to the DNC model in the target domain (and/or node) (e.g., at the first timestamp of the timeseries at the target domain).

There may be multiple benefits realized from being able to do transfer learning via the memory of the DNC, e.g., because of the flexibility of this technique. The technique does not require for the dimensions of the input features of the source and the target to be the same. This may be useful in cases where there are additional features added to the target data/domain, but such additional features cannot be added for the source data/domain, for example, if a network operator adds a new set of sensors to a node, when monitoring capabilities are upgraded/improved in the network infrastructure, when a source domain is associated with a source node which has different capabilities (e.g., sensors, measurements, etc.) than those of the target node associated with the target domain, etc.

As an example, consider the performance metrics (features) monitored from a base station in connection to the requirements and guidelines from a current release of a communications standard (e.g., a third generation partnership project (3GPP) wireless communication standard). Given the new requirements from the future release of the standard, a network operator may monitor additional performance metrics (features) for the target domain, for example, to comply with the updated guidelines in the 3GPP standard. In this case, the target and source have different (overlapping) features as they fulfill requirements from different releases of the standard.

Furthermore, the techniques described herein may increase flexibility compared to known techniques because one does not need to use the same controller in the source and the target. For example, the source DNC may use a feed-forward neural network while the target DNC uses a recurrent neural network. The family of recurrent neural networks includes, for example, LSTM, multi-layer perceptrons (MLP), convolutional neural network (CNN). Other neural network architectures may be used without deviating from the scope of the present disclosure.

One advantage of the transferring method disclosed herein compared to training the DNC according to prior art techniques is that the transferring method disclosed herein may aid the DNC in learning how to interact with the external memory. This is motivated by at least two reasons. Firstly, by having a memory that contains useful information already from the first epoch, the controller in the DNC will be encouraged to emit an encoding at each time step that is similar to the contents in the memory in order to read information from it through content-based addressing. In this way, the controller may learn how to encode the data in a similar way to how the source model encoded the data. Secondly, after reading from memory, the predictive layer may need to learn how to make a prediction based on what has been read. For these two aspects, transfer learning method disclosed herein may encourage the target to learn how to interact with the memory and potentially could improve the convergence rate.

Another possible benefit of the techniques disclosed herein is that new information may be brought from the source to the target. The transferred memory may contain encodings of the source data. This memory contains information that may be useful for the target model so that the target model is able to better generalize. For example, the predictive layer may possibly encounter a more diverse set of read vectors 20 by reading from both the source memory and target memory created after it has been updated with the target timeseries.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example neural network architecture;

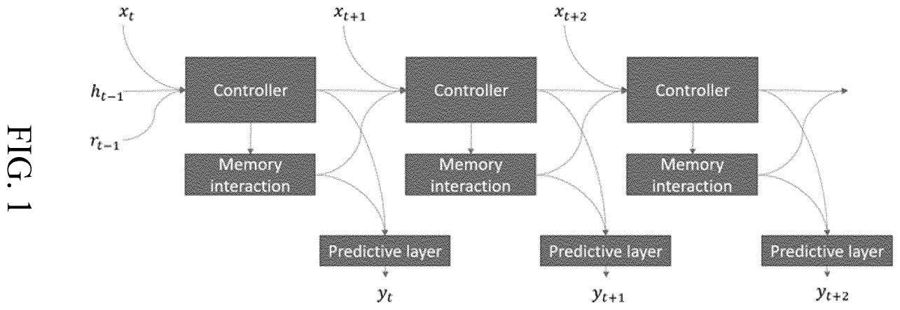

FIG. 2 is a schematic diagram of an example network architecture illustrating a communication system according to principles disclosed herein;

FIG. 3 is a block diagram of a network node in communication with a wireless device over a wireless connection according to some embodiments of the present disclosure;

FIG. 4 is a flowchart of an example process in a source network node for training a source model and transferring the learning to a target model according to some embodiments of the present disclosure;

FIG. 5 is a flowchart of an example process in a target network node for training a target model based on learning transferred from a source model according to some embodiments of the present disclosure;

FIG. 6 is a flowchart of an example process in a source domain and a target domain according to some embodiments of the present disclosure;

FIG. 7 is a schematic diagram of an example neural network architecture according to some embodiments of the present disclosure; and

FIG. 8 is a chart depicting results of an example use case according to some embodiments of the present disclosure.

### DETAILED DESCRIPTION

Before describing in detail exemplary embodiments, it is noted that the embodiments reside primarily in combinations of apparatus components and processing steps related to training a source model and transferring the learning to a target model. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a network which may further comprise any of a server, cloud computing device, computer, wireless communication network base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

In some embodiments, the network node may be a wireless device and/or may be a computer/server (e.g., a cloud-computing server, a data center server, etc.).

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Such terminology is provided solely to aid understanding of the concepts of the disclosure, and to provide examples of possible implementations of the disclosure. Other systems, including without limitation Wide Band Code Division Multiple Access (WCDMA), Worldwide Interoperability for Microwave Access (WiMax), Ultra Mobile Broadband (UMB) and Global System for Mobile Communications (GSM) and wired networks may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to transferring learning from a source model to a target model.

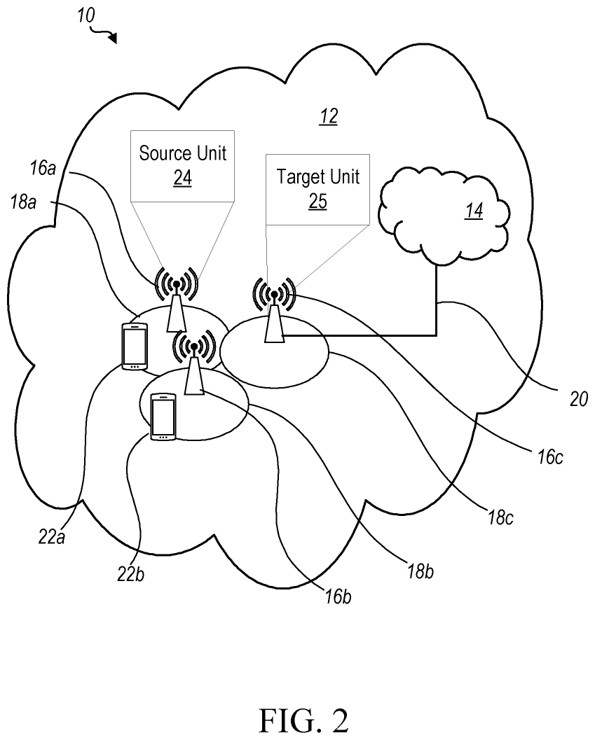

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A source network node 16 (for example an eNB or gNB for implementations in a 3GPP environment) is configured to include a source unit 24 which is configured to train a source model and transfer learning to a target model. A target network node 16 is configured to include a target unit 25 which is configured to train a target model based on the transferred learning from the source model. The source network node 16 and the target network node 16 may be different nodes, or may be the same node (e.g., in a case where the network node 16 is upgraded with new hardware and/or software capabilities, the source network node 16 may refer to the network node 16 pre-upgrade, and the target network node 16 would refer to the network node 16 post-upgrade).

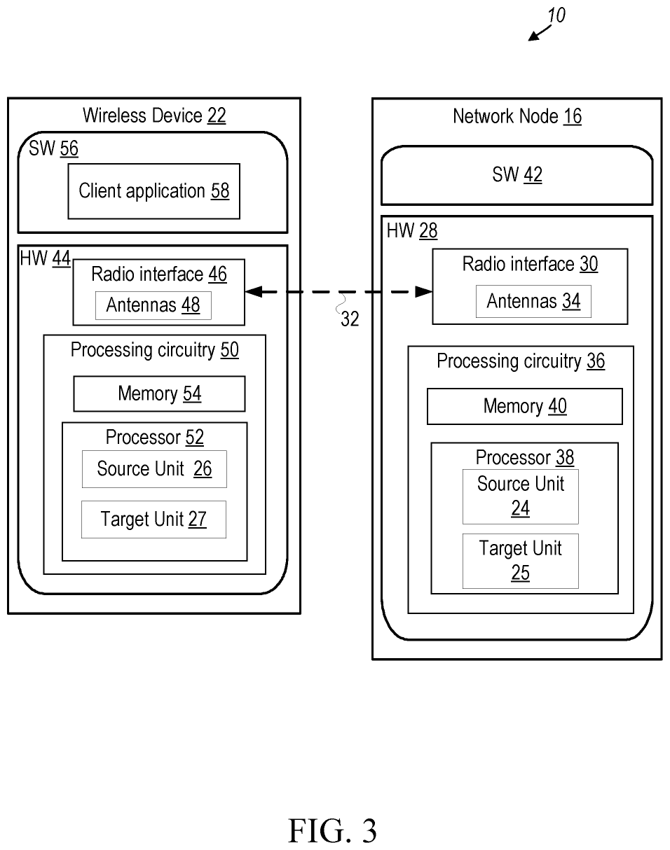

Example implementations, in accordance with an embodiment, of the wireless device 22 and network node 16 discussed in the preceding paragraphs will now be described with reference to FIG. 3.

The communication system 10 includes a network node 16 (e.g., the source network node 16 and/or the target network node 16) provided in a communication system 10 and including hardware 28 enabling it to communicate with the WD 22 (for example implementations based on a 3GPP standard). The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 which is a source network node 16 may include source unit 24 which is configured to train a source model and transfer learning to a target model. As another example, processing circuitry 36 of the network node 16 which is a target network node 16 may include target unit 25 which is configured to train a target model based on the transferred learning from the source model.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. Although not depicted in FIG. 3, WD 22 may have a source unit and/or target unit with similar structure and function as the source unit 24 and/or target unit 25 of the network node 16, and the teachings herein with regard to the source network node 16 and target network node 16 may be applied to a source WD 22 and a target WD 22 which are in communication with one another, and/or to a single WD 22 which includes both a source unit and a target unit.

In some embodiments, the inner workings of the network node 16 and WD 22 may be as shown in FIG. 3 and independently, the surrounding network topology may be that of FIG. 2.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 2 and 3 show various “units” such as source unit 24 and target unit 25 as being within a respective processor, it is contemplated that these units may be implemented such that a portion of the unit is stored in a corresponding memory within the processing circuitry. In other words, the units may be implemented in hardware or in a combination of hardware and software within the processing circuitry. In some embodiments, the source node 16 can be the same as the target node 16, e.g., both are implemented in node 16a. In other embodiments, the source node 16 can be different from the target node 16, e.g., the source node is node 16a and the target node is node 16b. Thus, source unit 24 can be in the same or a different network node 16 than target unit 25.

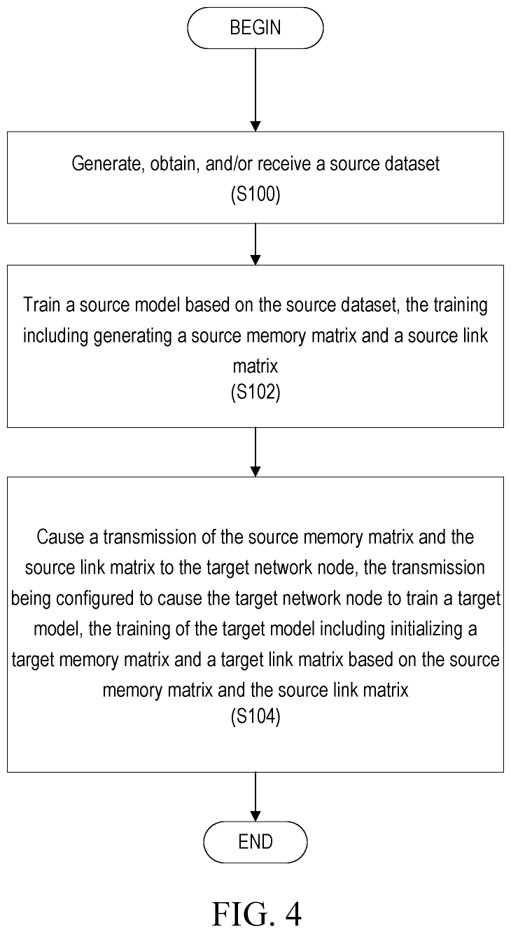

FIG. 4 is a flowchart of an example process in a source network node 16 for transferring learning from a source model to a target model. One or more blocks described herein may be performed by one or more elements of source network node 16 such as by one or more of processing circuitry 36 (including the source unit 24 and the target unit 25), processor 38, and/or radio interface 30. Source network node 16 is configured to generate, obtain, and/or receive (Block S100) a source dataset. Source network node 16 is configured to train (Block S102) a source model based on the source dataset, the training including generating a source memory matrix and a source link matrix. Source network node 16 is configured to cause a transmission (Block S104) of the source memory matrix and the source link matrix to the target network node 16, the transmission being configured to cause the target network node 16 to train a target model, the training of the target model including initializing a target memory matrix and a target link matrix based on the source memory matrix and the source link matrix.

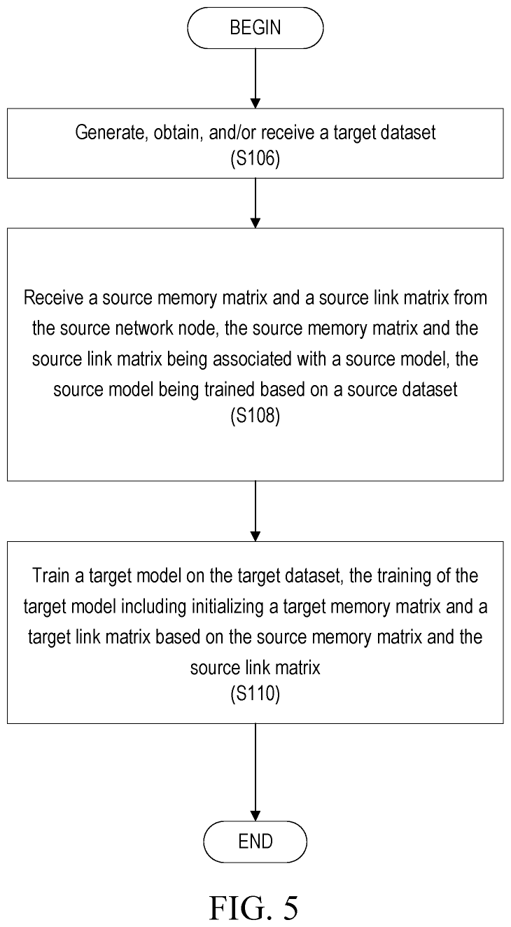

FIG. 5 is a flowchart of an example process in a target network node 16 for transferring learning from a source model to a target model. One or more blocks described herein may be performed by one or more elements of target network node 16 such as by one or more of processing circuitry 36 (including the source unit 24 and the target unit 25), processor 38, and/or radio interface 30. Target network node 16 is configured to generate, obtain, and/or receive (Block S106) a target dataset. Target network node 16 is configured to receive (Block S108) a source memory matrix and a source link matrix from the source network node 16, the source memory matrix and the source link matrix being associated with a source model, the source model being trained based on a source dataset. Target network node 16 is configured to train (Block S110) a target model on the target dataset, the training of the target model including initializing a target memory matrix and a target link matrix based on the source memory matrix and the source link matrix.

Having described the general process flow of arrangements of the disclosure and having provided examples of hardware and software arrangements for implementing the processes and functions of the disclosure, the sections below provide details and examples of arrangements for transfer learning from a source node 16 to a target node 16.

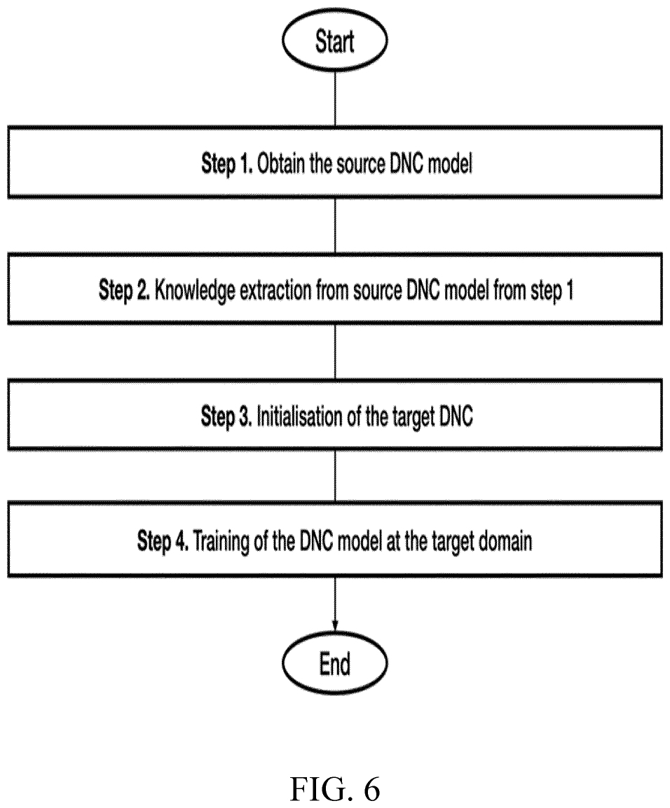

In some embodiments, the following steps are performed for transferring knowledge from a source DNC (implemented in a source network node 16) to a target DNC (implemented in target network node 16). A flowchart including these steps is depicted in FIG. 6.

### Step 1: Obtain a Source DNC Model.

“Source DNC model” may refer to a DNC model received from a source, where the source may be any node, dataset, domain, etc., e.g., a source network node 16, a source WD 22, a source cloud-based server, etc. In the case where the DNC model is obtained from a network node 16 (e.g., an gNodeB, eNodeB, etc.), such node may be referred to as a source network node 16. The source may be in a different node or may be in the same node 16 as the target DNC model. As an example, the source may be in a source network node 16, and the target may be in another network node 16, e.g., a target network node 16. Alternatively, the source DNC may refer to a model previously trained on a network node 16, e.g., before an upgrade is performed on network node 16. Further, the target may refer to the domain on the same network node 16 as the source but after an upgrade occurs.

The source DNC model may be a candidate model selected from a source domain (e.g., by processing circuitry 36, including the source unit 24). The source DNC model may have already been trained on a dataset obtained from the source, where the source may be, e.g., a network node 16, and the dataset may comprise values related to the network node 16, such as measurements, performance, etc., and may include, e.g., downlink/uplink frequency, speed, latency, throughput, power, beamforming related features, including, e.g., UL_WideBeamRsrp, DL_WideBeamRsrp, UL_NarrowBeamRSRP, DL_NarrowBeamRSRP, BeamManagement, etc. The source DNC model may be fully trained given the data available at the source domain.

The source domain may be in one device/node/etc. and the target domain may be in the same or another device/node/etc. For example, the source may be in one network node 16 (e.g., radio base station/gNB/eNB/etc.), and the target may be in another network node 16. The source may be in one server of a data center, and the target in another server (i.e., of the same data center or of a different data center). As another example, the source may be on one wireless device 22, and the target in another wireless device 22. The domain may refer to an execution environment on the same node before and after change a change the environment. For example, the source may be an environment at a network node 16/data center/wireless device 22/etc. before an upgrade, and target refers to the environment after the upgrade.

The source DNC model may be chosen to best suit the target domain/dataset. For example, in some embodiments, the source DNC model may be an average model from multiple source DNC models, where an average is calculated by taking an average of the parameters of one or more DNC models. The average may be a an arithmetic mean, or may be a weighted averaging (e.g., weighting certain parameters more than others). Other techniques for selecting a source DNC model and/or target DNC model may be utilized without deviating from the scope of the present disclosure.

The selected source DNC model may be trained on the source dataset/domain, e.g., such as by processing circuitry 36 (including the source unit 24).

Step 2: Knowledge Extraction from Source DNC Model

Step 2 includes extracting (e.g., by processing circuitry 36, including the source unit 24) the memory matrix and link matrix from the source DNC model at the final timestamp of the training phase/period (i.e., of the source DNC model). This may also be referred to as the “experience” of the model. Extraction may include reusing the memory matrix and link matrix.

Once a source DNC is trained (e.g., by processing circuitry 36, including the source unit 24), some or all of its optimized parameters may be accessed, which may include a memory matrix and a link matrix. The sizes of these matrices may depend on the number of features (e.g., of the source domain/dataset). For example, the memory matrix may contain a number of rows (e.g., memory locations) where the length of each row may indicate the length of the embeddings. The number of rows may depend on the computational resources available. It may be advantageous to have more rows (e.g., memory locations) irrespective of the number of features, although that may require additional computational resources in the training phase. The length of the embedding may be indirectly related to the number of features. It may be smaller or equal to the number of features. The exact length of the embedding may depend on the use case and/or the length of the features. If there were no constraints on the computational resources, it may be equal to the length of features.

The link matrix may also be referred to as the temporal memory linkage. This matrix is a square matrix with the number of rows and columns equal to the number of memory locations (the number of rows of the memory matrix).

The memory matrix and the link matrix of the target DNC may be selected (e.g., by processing circuitry 36, including the source unit 24) to have the same size or a larger size than the memory matrix and the link matrix of the source DNC. If they do not have the same size, the memory matrix and link matrix of the source DNC may be used to partially initialize the memory matrix and the link matrix of the target DNC. The memory matrix and the link matrix of the target DNC may be selected to be larger than the ones in the source DNC. The empty memory locations of the target memory matrix and link matrix may be initialized with zeros (e.g., by processing circuitry 36, including the source unit 24).

### Step 3: Initialization of the Target DNC

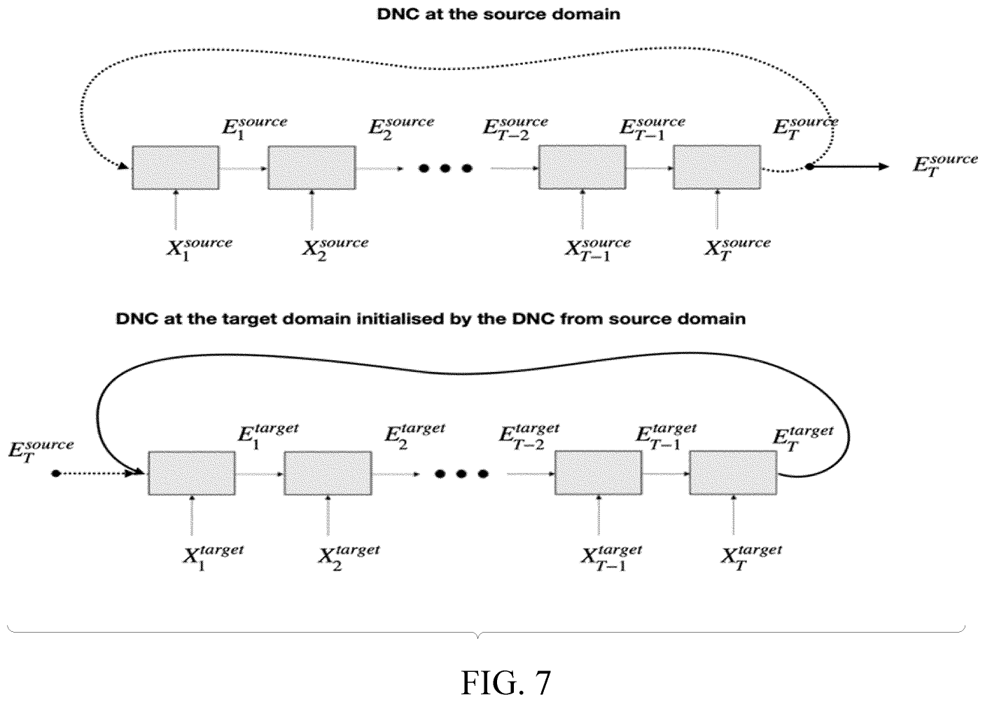

Step 3 includes initializing (e.g., by processing circuitry 36, including the target unit 25) the memory matrix and the link matrix of the target DNC model at the first timestamp (i.e., of the target DNC model) with the ones from Step 2, as shown in FIG. 7. This may include the values of the extracted memory matrix and link matrix of Step 2 being used in the memory matrix and the link matrix of Step 3. In other words, they may be used for the initialization of the memory matrix and link (linkage) matrix (e.g., by processing circuitry 36, including the target unit 25). The target DNC model can be on a different node/device/etc. (e.g., target network node 16) than the source DNC. The source DNC may only be used for initialization.

FIG. 7 depicts an example procedure for transferring knowledge from a source DNC model to a target DNC model. The source DNC model is fully trained (e.g., by processing circuitry 36, including the source unit 24) on the timeseries in source domain,

$${X}_{1}^{source} , {X}_{2}^{source} , … , {X}_{T}^{source} .$$

### In FIG. 7,

$${X}_{i}^{source}$$

shows the i-th data sample in the source domain.

$${E}_{i}^{source}$$

is a set that includes the memory matrix

$${M}_{i}^{source}$$

and link matrix

$${L}_{i}^{source}$$

at the i-th timestamp. Similarly,

$${E}_{T}^{source}$$

shows the knowledge set at the last timestamp T. The DNC model at the target domain, i.e., the target DNC model, is initialized by the knowledge set from the source domain (e.g., by processing circuitry 36, including the target unit 25). This is done by initializing

$${E}_{1}^{target}$$

at the first epoch by

$${E}_{T}^{target} ,$$

which is by initializing the memory matrix

$${M}_{1}^{target}$$

and the link matrix

$${L}_{1}^{target}$$

by the memory matrix

$${M}_{T}^{source}$$

and the link matrix

$${L}_{T}^{source}$$

of the source domain. Once the DNC is initialized, it may be trained (e.g., by processing circuitry 36, including the target unit 25) using available data in the target domain,

$${X}_{1}^{target} , {X}_{2}^{target} , … , {X}_{T}^{target} .$$

### Step 4: Training of the DNC Model at the Target Domain

Step 4 includes performing training of the target DNC model (e.g., by processing circuitry 36, including the target unit 25) in the target domain (e.g., based on the data associated with the target node).

### Use Case Examples and Verification

One example use case includes Prediction of round-trip-time (RTT) given network node 16 (e.g., base station) data.

For this example, a dataset including data samples collected from a 5G mmWave testbed may be used. In the example testbed, the data may be gathered from four different sources that make up a 5G network; a user (e.g., wireless device 22), eNodeB (e.g., network node 16), an Evolved Packet Core (EPC) (e.g., core network 14), and the internet/cloud.

The source dataset and the target dataset may contain features extracted from the logs at the user equipment (e.g., wireless device 22) level and logs from the radio interface (e.g., network node 16) and core network 14 levels (e.g., by processing circuitry 36, including the source unit 24). For example, for the case of the source dataset, the wireless device 22 may be static, and there may be a total of N features available, and for the case of the target dataset, the wireless device 22 may be moving and there may be a total of M features. In one example, N=636 features, and M=495 features.

These features may include downlink, uplink, beamforming related features.

The following are some non-limiting examples of features: ‘UL_timingOffset_1s’, ‘UL_preamblePwr_1s’, ‘UL_transmissionAttempt_1s’, ‘UL_BSRestimate_1s’, ‘UL_RI_1s’, ‘UL_macSduInBytes_1s’, ‘UL_powerHeadRoomIndex_1s’, ‘UL_pCmaxCIndex_1s’, ‘UL_VBit_1s’, ‘UL numberOfActivatedUlCells_1s’, ‘UL_WBeamRsrpCurrent_1s’, ‘UL_NBeamRsrpCurrent_1s’, ‘UL_isPrimaryCell_1s’, ‘UL_carrierAggregationUsed_1s’, ‘BeamMgmtNbm_ver_1s’, ‘BeamMgmtNbm_esfn_1s’, ‘BeamMgmtNbm_cellId_1s’, ‘DL_srWeight_10 ms’, ‘DL_ACK_10 ms’, ‘DL_DTX_10 ms’, ‘DL srOnPucch_10 ms’, ‘DL_transmissionAttempt_10 ms’, ‘DL pucchSfn_10 ms’, ‘DL_pucchSlotNo_10 ms’, ‘DL_feedbackIndex_10 ms’, ‘DL numberOfActivatedDICells_10 ms’, ‘DL_WBeamRsrpCurrent_10 ms’, ‘DL_NBeamRsrpCurrent_10 ms’, ‘DL_sinr_10 ms’, ‘DL_isPrimaryCell_10 ms’, ‘UL_ver_10 ms’, ‘UL_bbUeRef_10 ms’, ‘UL_esfn_10 ms’, ‘UL_slot_10 ms’, ‘UL_cellId_10 ms’, ‘UL_bbCellIndex_10 ms’, ‘UL_beamIndex_10 ms’, ‘UL_cRnti_10 ms’, ‘UL_dciFormat_10 ms’, ‘UL_fda_10 ms’, ‘UL_mcsIndex_10 ms’, ‘UL numOfPrbs_10 ms’, ‘UL_ndi_10 ms’, ‘UL_rv_10 ms’, ‘UL_harqProcessId_10 ms’, ‘UL_precodingInfo_10 ms’, ‘UL_antennaPorts_10 ms’, ‘UL_numOfLayers_10 ms’, ‘UL_isTransformPrecoding_10 ms’, ‘UL_tbSizeInBits_10 ms’, ‘UL_csiRequest_10 ms’, ‘UL nrOfCsiPart1Bits_10 ms’, ‘NrConnectedUEStats_drxActive_100 ms’, ‘NrConnectedUEStats drxInactive_100 ms’, ‘NrLegAdditionMessagesStats_ver_100 ms’, ‘NrLegAdditionMessagesStats_esfn_100 ms’, and ‘NrLegAdditionMessagesStats_slot_100 ms’.

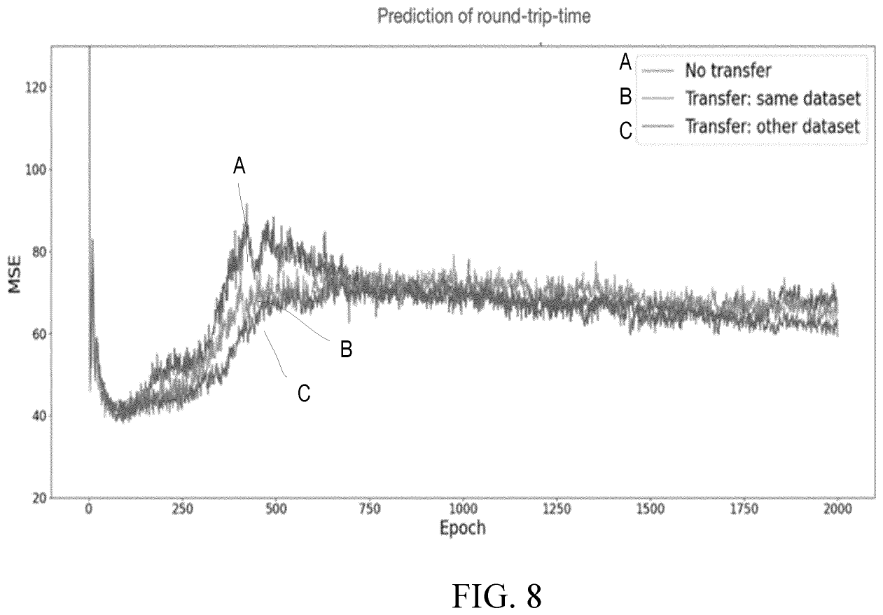

In this example application, the purpose is to predict the end-to-end latency of a 5G network given these features, that is, the time it takes to send a signal to a device and back original transmitter. FIG. 8 shows the experimental results for two transfer learning scenarios using techniques disclosed herein, in which data was collected for 10 minutes producing a timeseries of 600 timestamps. In FIG. 8, performance of the DNC model trained in the target domain with and without transfer learning. In the case of the “different dataset” the source DNC is trained on data collected from a static wireless device 22. For the case of the same dataset, the source DNC is trained on data collected from a moving wireless device 22 (the same environment as the target domain). The performance is evaluated in terms of mean-square-error (MSE) where the lower values are preferred. FIG. 8 illustrates that, in both cases, there is a gain in the case of transfer learning.

Training the source DNC—A DNC is trained on the source dataset (e.g., according to Step 1 described above). The source DNC model has been trained to predict the RTT given base station features. Steps 2, 3, and 4 (described above) are then performed.

Other applications which may utilize the techniques of the present disclosure include: Prediction of service level metrics given features from a data center, where the source DNC in this case is from one server and the target DNC can be in another server; and key performance indicator (KPI) prediction given data collected from wireless devices' 22 mobile network data, where the source and target are two different wireless devices 22

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1. A source network node configured to communicate with a target network node, the source network node one or more of configured to, comprising a radio interface and comprising processing circuitry configured to:
one or more of generate, obtain, and receive a source dataset;
train a source model based on the source dataset, the training including generating a source memory matrix and a source link matrix; and
cause a transmission of the source memory matrix and the source link matrix to the target network node, the transmission being configured to cause the target network node to train a target model, the training of the target model including initializing a target memory matrix and a target link matrix based on the source memory matrix and the source link matrix.

2. The source network node according to claim 1, wherein each of the source model and the target model is a differentiable neural computer, DNC, model.

3. The source network node according to claim 1, wherein the source memory matrix and the source link matrix are associated with a final timestamp of the source model.

4. The source network node according to claim 1, wherein each of the source dataset and the target dataset is a timeseries dataset.

5. The source network node according to claim 1, wherein the source dataset is associated with a source domain, the target dataset being associated with a target domain different from the source domain.

6. The source network node according to claim 1, wherein the source dataset is associated with performance indicators associated with the source network node.

7. (canceled)

8. A method implemented in a source network node configured to communicate with a target network node, the method comprising:
one or more of generating, obtaining, and receiving a source dataset;
training a source model based on the source dataset, the training including generating a source memory matrix and a source link matrix; and
causing a transmission of the source memory matrix and the source link matrix to the target network node, the transmission being configured to cause the target network node to train a target model, the training of the target model including initializing a target memory matrix and a target link matrix based on the source memory matrix and the source link matrix.

9. The method according to claim 8, wherein each of the source model and the target model is a differentiable neural computer, DNC, model.

10. The method according to claim 8, wherein the source memory matrix and the source link matrix are associated with a final timestamp of the source model.

11. The method according to claim 8, wherein each of the source dataset and the target dataset is a timeseries dataset.

12.-14. (canceled)

15. A target network node configured to communicate with a source network node, the target network node one or more of configured to, comprising a radio interface and comprising processing circuitry configured to:
one or more of generate, obtain, and receive a target dataset;
receive a source memory matrix and a source link matrix from the source network node, the source memory matrix and the source link matrix being associated with a source model, the source model being trained based on a source dataset; and
train a target model on the target dataset, the training of the target model including initializing a target memory matrix and a target link matrix based on the source memory matrix and the source link matrix.

16. The target network node of claim 15, wherein each of the source model and the target model is a differentiable neural computer, DNC, model.

17. The target network node according to claim 15, wherein the source memory matrix and the source link matrix are associated with a final timestamp of the source model.

18. The target network node according to claim 15, wherein each of the source dataset and the target dataset is a timeseries dataset.

19. The target network node according to claim 15, wherein the source dataset is associated with a source domain, the target dataset being associated with a target domain different from the source domain.

20. (canceled)

21. The target network node according to claim 15, wherein the target dataset is associated with performance indicators associated with the target network node.

22. A method implemented in a target network node configured to communicate with a source network node, the method comprising:
one or more of generating, obtaining, and receiving a target dataset;
receiving a source memory matrix and a source link matrix from the source network node, the source memory matrix and the source link matrix being associated with a source model, the source model being trained based on a source dataset; and
training a target model on the target dataset, the training of the target model including initializing a target memory matrix and a target link matrix based on the source memory matrix and the source link matrix.

23. The method according to claim 22, wherein each of the source model and the target model is a differentiable neural computer, DNC, model.

24. The method according to claim 23, wherein the source memory matrix and the source link matrix are associated with a final timestamp of the source model.

25. The method according to claim 22, wherein each of the source dataset and the target dataset is a timeseries dataset.

26.-28. (canceled)
